(19) United States
(12) Patent Application Publication
(10) Pub. No.: US 2026/0063443 A1
(43) Pub. Date: Mar. 5, 2026

(54) AUTONOMOUS DRIVING MAP GENERATION DEVICE

(71) Applicant: LKSYS INC., Seoul (KR)

(72) Inventors: Huiwon LEE, Seoul (KR); Hongseung ROH, Sejong (KR)

(73) Assignee: LKSYS INC., Seoul (KR)

(21) Appl. No.: 19/106,640

(22) PCT Filed: Aug. 18, 2023
(86) PCT No.: PCT/KR2023/012257

§ 371 Date: Feb. 26, 2025

(30) Foreign Application Priority Data
Sep. 1, 2022 (KR) 10-2022-0110680

(51) Int. Cl. G01C 21/00; B60W 60/00

(52) U.S. Cl. CPC G01C 21/3837; G01C 21/3811; B60W 60/00; B60W 2554/20; B60W 2556/40; B60W 2556/45

(57) ABSTRACT

Disclosed is an autonomous driving map generation device, wherein the autonomous driving map generation device reflects, in generating a high-precision map for autonomous driving in a terminal, relative positions of a fixed object marker of a hidden fixed object and a moving object marker corresponding to a moving object in a high-precision map on the basis of a fixed position of the fixed object to improve positioning accuracy in an autonomous vehicle in the terminal.

### TECHNICAL FIELD

The present invention relates to an autonomous driving map generation device.

### BACKGROUND ART

The following description merely provides background information related to the present invention and does not define a prior art.

An autonomous driving system refers to a system that can travel automatically to a predetermined destination by recognizing surrounding situations and a vehicle status by itself without driver's operation. The autonomous driving system includes a recognition process, a decision-making process, a path generation process, and a vehicle control process. The path generation process is a process of detecting changes in obstacles, generating an avoidance path in real time, and generating a path in which mechanical behavior characteristics of a vehicle are considered.

In particular, in the path generation process, since various dangerous situations may occur when an autonomous vehicle attempts to change lanes in urban areas, congested sections, and highways where unexpected changes occur in real time, a stable driving path should be created in consideration of collisions with surrounding dynamic obstacles. Therefore, techniques for generating driving paths that enable stable lane changes in the autonomous vehicle have been proposed.

In general, the autonomous vehicle recognizes both lines of a traveling lane, and travels in the center of the recognized two lines. The autonomous vehicle generates a candidate path in the lane in consideration of surrounding vehicles or obstacles, and selects a local path within the lane (between both lines of the traveling lane) to avoid collision with obstacles and secure safety, and travels in a state of being biased from the center of the lane.

Generally, the autonomous vehicle stores a high-precision map for a specific area for driving in the specific area, and measures its position on the basis of the position of an externally recognized identifier. However, in a case where the external identifier is hidden by a structure in a specific area, the position of the external identifier may not be accurately measured, which may cause problems.

### DISCLOSURE OF INVENTION

### Technical Problem

The present invention has been made in view of the above problems, and it is an object of the present invention to provide an autonomous driving map generation device, capable of reflecting relative positions of a fixed object marker of a hidden fixed object and a moving object marker corresponding to a moving object in a high-precision map on the basis of a fixed position of the fixed object to generate a high-precision map for autonomous driving in the terminal, thereby improving positioning accuracy in an autonomous vehicle in the terminal.

### Technical Solution

In accordance with the present invention, the above object can be accomplished by the provision of an autonomous driving map generation device including a fixed object-based map generating part that generates a first high-precision map for autonomous driving on the basis of a fixed position corresponding to a fixed object, a first moving object-based map generating part that recognizes a fixed object marker corresponding to the fixed object on the basis of a first moving object LiDAR provided in a first moving object to generate a second high-precision map for autonomous driving, a second moving object-based map generating part that recognizes a first moving object marker corresponding to the first moving object on the basis of a second moving object LiDAR provided in a second moving object to generate a third high-precision map for autonomous driving, and an autonomous driving providing part that transmits the second high-precision map to the first moving object for autonomous driving, and transmits the third high-precision map to the second moving object for autonomous driving.

In accordance with an aspect of the present invention, the above object can be accomplished by the provision of an autonomous driving map generation device including an integrated map generating part that reflects a fixed position corresponding to a fixed object, reflects a position of the fixed object based on a fixed object marker corresponding to the fixed object recognized on the basis of a first moving object LiDAR provided in a first moving object, reflects a position of the first moving object based on a first moving object marker recognized on the basis of a second moving object LiDAR provided in a second moving object, and reflects a position of the second moving object based on a second moving object marker recognized on the basis of the second moving object LiDAR, in an integrated high-precision map for autonomous driving, and an autonomous driving providing part that transmits the integrated high-precision map to the first moving object and the second moving object for autonomous driving.

### Advantageous Effects

As described above, according to the present invention, in generating a high-precision map for autonomous driving in a terminal, it is possible to reflect relative positions of a fixed object marker of a hidden fixed object and a moving object marker corresponding to a moving object in a high-precision map on the basis of a fixed position of the fixed object to improve positioning accuracy in an autonomous vehicle in the terminal.

### BRIEF DESCRIPTION OF DRAWINGS

FIG. 1 is a diagram illustrating an autonomous driving map generation system according to an embodiment of the present invention;

FIG. 2A is a schematic diagram showing an autonomous driving map generation device according to a first embodiment of the present invention;

FIG. 2B is a schematic diagram showing an autonomous driving map generation device according to a second embodiment of the present invention;

FIG. 3 is a diagram showing a fixed object, a first moving object, a second moving object located in a terminal according to a present embodiment of the invention;

FIG. 4 is a diagram showing a first high-precision map, a second high-precision map, and a third high-precision map according to the first embodiment of the present invention; and

FIG. 5 is a diagram showing a high-precision map according to the second embodiment of the present invention.

### REFERENCE SIGNS

110: Fixed object
120: First moving object
130: Second moving object
200: Autonomous driving map generation device

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts.

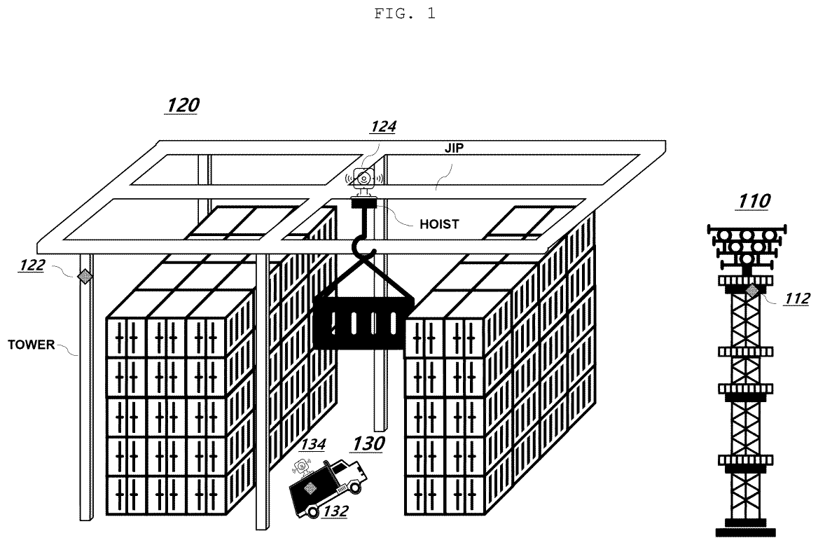

FIG. 1 is a diagram illustrating an autonomous driving map generation system according to an embodiment of the present invention.

The autonomous driving map generation system according to the present embodiment includes a fixed object 110, a first moving object 120, a second moving object 130, and an autonomous driving map generation device 200. Components included in the autonomous driving map generation system are not necessarily limited thereto.

The fixed object 110 includes a light tower and a fixed object marker 112. The fixed object 110 may include the light tower as an example. The fixed object 110 has fixed GPS latitude and longitude values.

The fixed object 110 (e.g., light tower) is located in a terminal. In a case where the fixed object 110 is the light tower, the light tower serves to illuminate the entire terminal. The fixed object 110 includes the fixed object marker 112 attached to the light tower.

The first moving object 120 includes a gantry crane or a transportable crane. The first moving object 120 moves slowly. A first moving object marker 122 for position recognition is attached to the first moving object 120.

The gantry crane and transportable crane included in the first moving object 120 may be driven autonomously on the basis of a second high-precision map to be described later. The first moving object 120 may measure its position on the basis of the fixed object marker 112 corresponding to the fixed object 110, and may perform autonomous driving on the basis of the second high-precision map.

The gantry crane refers to a large crane with a support device. The gantry crane is a lifting device with a cantilever-type girder that moves along a rail or with a tire to move cargo blocks and a column.

The gantry crane may include a tower, a jib and a hoist. The tower is a column that supports the hoist. The jib is a device that guides the hoist to its destination, and is arranged horizontally in an upper part of the crane. The hoist is a device that moves along the jib, lifts and moves the cargo blocks using a cable, a winch, and or a pulley. Each cargo block refers to a standardized metal box, for example, a container.

The transportable crane is a crane that can move the cargo blocks to an unspecified location. The transportable crane may also include a tower, a jib, and a hoist system.

The gantry crane or transportable crane stacks up the cargo blocks.

The second moving object 130 includes a yard truck, an external truck, a reach stacker, or the like that can perform autonomous driving with the cargo blocks loaded thereon. A second moving object marker 132 capable of recognizing a position of the second moving object 130 is attached to the second moving object 130.

The second moving object 130 recognizes the fixed object marker 112 of the fixed object 110 as a first priority and the first moving object marker 122 of the first moving object 120 as a second priority to measure its position.

The yard truck refers to an autonomous vehicle that carries cargo blocks only in a terminal. The yard truck tows a trailer attached thereto to carry cargo blocks. The cargo blocks are loaded on the trailer attached to the yard truck. The yard truck travels with a second moving object LiDAR 134 attached thereto for autonomous driving.

The yard truck travels between stacked cargo blocks. The yard truck travels in the terminal in an autonomous manner. The yard truck measures its position for autonomous driving on the basis of a recognized marker using the second moving object LiDAR 134.

To this end, the yard truck reads the fixed object marker 112 of the fixed object 110 at a fixed position using the second moving object LiDAR 134. The yard truck checks whether the fixed object marker 112 of the fixed object 110 matches an object on a high-precision map.

The yard truck reads the first moving object marker 122 of the second moving object 130 using the second moving object LiDAR 134. The yard truck checks whether the first moving object marker 122 of the first moving object 120 matches an object on the high-precision map.

As a result of comparison with the high-precision map, in a case where three or more fixed object markers 112 and first moving object markers 122 are recognized, the yard truck measures its position on the basis of three or more fixed object markers 112 and first moving object markers 122.

Thus, in a case where the yard truck travels in the terminal, even if there is no GPS signal, the yard truck can perform autonomous driving.

The yard truck receives a high-precision map from the autonomous driving map generation device 200 that is located within a 5 km to 10 km radius around the terminal where the yard truck travels. As the yard truck moves, the yard truck continues to receive the high-precision map from the autonomous map generation device 200.

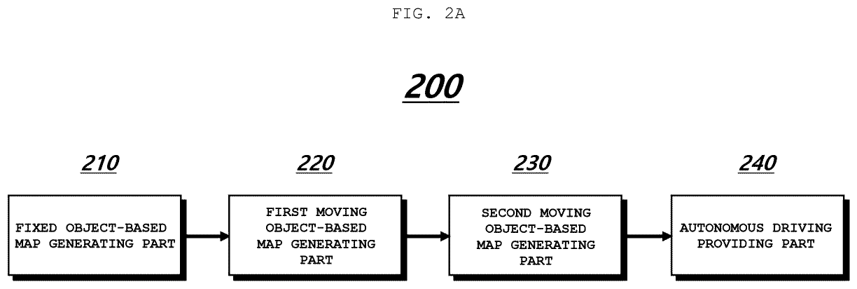

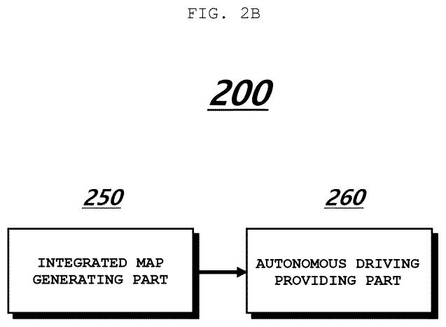

FIG. 2A is a schematic diagram showing an autonomous driving map generation device according to a first embodiment of the present invention.

Cargo blocks are usually stacked in 5 to 8 stages using a gantry crane or transportable crane in the terminal. The cargo blocks in the terminal are repeatedly accumulated and transported in accordance with the movement of the cargo blocks. A plurality of cranes may be used to stack the cargo blocks.

The cargo blocks are transported and re-accumulated in a new shape in a predetermined period unit (for example, a week). The cargo blocks stacked in the terminal have different shapes and widths depending on the number of stages and the number of cargo blocks. Due to the high accumulation of the cargo blocks, the fixed object marker 112 of the fixed light tower may not be visible, which may cause problems.

The autonomous driving generation device 200 performs tagging operations for respective objects located in the terminal to assign markers thereto. The autonomous driving map generation device 200 transmits information on the marker to a vehicle that travels autonomously in the terminal.

The autonomous driving map generation device 200 reflects the position of the first moving object 120 and the position of the second moving object 130 in a high-precision map to generate data prepared to be read by the second moving object 130, and transmits the result to the second moving object 130.

The autonomous driving map generation device 200 generates a first high-precision map based on a fixed position on the basis of the fixed object marker 112 of the fixed object 110. The autonomous driving map generation device 200 generates a second high-precision map based on the position of a moving object on the basis of the first moving object marker 122 of the first moving object 120. The autonomous map generation device 200 generates a third high-precision map based on the position of a moving object on the basis of the second moving object marker 132 of the second moving object 130.

The autonomous driving map generation device 200 recognizes the fixed object marker 112 of the fixed object 110 using a first moving object LiDAR 124 provided in the first moving object 120. Thus, in a case where the fixed object marker 112 of the fixed object 110 is hidden by the cargo blocks stacked in the terminal, the autonomous driving map generation device 200 recognizes the fixed object marker 112 of the fixed object 110 using the first moving object LIDAR 124 provided in the first moving object 120. The autonomous driving map generation device 200 may measure the position of the first moving object 120 on the basis of the fixed object marker 112.

The autonomous driving map generation device 200 reflects the position of the first moving object 120 in the second high-precision map. The autonomous driving map generation device 200 may accurately measure its position by recognizing the fixed object marker 112 attached to the fixed object 110 using the first moving object LiDAR 124.

In a case where there are the plurality of first moving objects 120 around the fixed object 110 in the terminal, the autonomous driving map generation device 200 recognizes the fixed object marker 112 using the first moving object LiDAR 124 to measure the positions of the first moving objects 120, and reflects the positions of the first moving objects 120 in the second high-precision map.

The autonomous driving map generation device 200 may recognize the second moving object marker 132 of the second moving object 130 using the second moving object LiDAR 134 of the yard truck to generate a third high-precision map, and may accurately measure the position of the yard truck using the third high-precision map.

The autonomous driving map generation device 200 reflects the first moving object marker 122 corresponding to the first moving object 120 and the second moving object marker 132 corresponding to the second moving object 130 in a database to generate a high-precision map.

The autonomous driving map generation device 200 may measure the position of the yard truck that is the second moving object 130 using the first moving object marker 122 corresponding to the first moving object 120 in the terminal even in a case where the fixed object marker 112 corresponding to the fixed object 110 is hidden by the cargo blocks stacked in the terminal.

The autonomous driving map generation device 200 generates the first high-precision map to be defined for each yard. The autonomous driving map generation device 200 generates the first high-precision map so as to include the location information of fixed object marker 112 of the fixed object 110.

On the basis of the first high-precision map, the autonomous driving map generation device 200 recognizes the fixed object marker 112 of the fixed object 110 using the first moving object LiDARs 124 provided in the first moving objects 120 (plural cargo trailers), and reflects the result in the second high-precision map. The autonomous driving map generation device 200 measures the position of the first moving object 120 on the basis of the fixed object marker 112, and then reflects the position of the first moving object 120 in the second high-precision map.

The autonomous driving map generation device 200 reflects the position of the fixed object 110 and the position of the first moving object 120 to generate the second high-precision map. The autonomous driving map generation device 200 recognizes the first moving object marker 122 of the first moving object 120 using the second moving object LiDAR 134 provided in the second moving object 130 to measure the position of the second moving object 130.

The autonomous driving map generation device 200 reflects the position of the second moving object 130 in the second high-precision map to generate the third high-precision map.

The autonomous driving map generation device 200 according to the first embodiment includes a fixed object-based map generating part 210, a first object-based map generating part 220, a second moving object-based map generating part 230, and an autonomous driving providing part 240. The components included in the autonomous driving map generation device 200 are not necessarily limited thereto.

The respective components included in the autonomous driving map generation device 200 may cooperate with each other through a communication path connecting software modules or hardware modules within the device. These components perform communication using one or more communication buses or signal lines.

Each component of the autonomous driving map generation device 200 shown in FIG. 2A refers to a unit that performs at least one function or operation, and may be implemented as a software module, a hardware module, or a combination thereof.

The fixed object-based map generating part 210 generates the first high-precision map for autonomous driving on the basis of the fixed position corresponding to the fixed object 110.

The fixed object map generating part 210 additionally reflects the fixed position corresponding to the fixed object 110 located in the terminal per yard in the map to generate the first high-precision map for autonomous driving.

The first moving object-based map generating part 220 recognizes the fixed object marker 112 corresponding to the fixed object 110 on the basis of the first moving object LiDAR 124 provided in the first moving object 120 to generate the second high-precision for autonomous driving.

The first moving object-based map generating part 220 recognizes the fixed object marker 112 corresponding to the fixed object 110 on the basis of the first moving object LiDAR 124. The first moving object-based map generating part 220 recognizes the fixed object marker 112 corresponding to the fixed object 110 hidden by cargo blocks stacked in the terminal on the basis of the first moving object LiDAR 124.

The first moving object-based map generating part 220 additionally reflects the position of the fixed object 110 based on the fixed object marker 112 and the position of the hidden fixed object 110 based on the hidden fixed object marker 112 in the first high-precision map to generate the second high-precision map for autonomous driving.

The first moving object-based map generating part 220 recognizes the plurality of first moving object markers 122 respectively corresponding to the plurality of first moving objects 120 on the basis of the first moving object LiDAR 124. The first moving object-based map generating part 220 additionally reflects the positions of the plurality of first moving objects 120 based on the plurality of first moving object markers 122 in the first high-precision map to generate the second high-precision map for autonomous driving.

The second moving object-based map generating part 230 recognizes the first moving object marker 122 corresponding to the first moving object 120 on the basis of the second moving object LiDAR 134 provided in the second moving object 130 to generate the third high-precision map for autonomous driving.

The second moving object-based map generating part 230 recognizes the plurality of second moving object markers 132 respectively corresponding to the plurality of second moving objects 130 on the basis of the second moving object LiDAR 134. The second moving object-based map generating part 230 additionally reflects the positions of the plurality of second moving objects 130 based on the plurality of second moving object markers 132 in the second high-precision map to generate the third high-precision map for autonomous driving.

The autonomous driving providing part 240 transmits the second high-precision map to the first moving object 120 for autonomous driving. The autonomous driving providing part 240 transmits the third high-precision map to the second moving object 130 for autonomous driving.

FIG. 2B is a schematic diagram showing an autonomous driving map generation device according to a second embodiment of the present invention.

The autonomous driving map generation device 200 measures a real-time position of a marker hidden by a moving object.

The autonomous driving map generation device 200 according to the second embodiment includes an integrated map generating part 250 and an autonomous driving providing part 260. The components included in the autonomous driving map generation device 200 are not necessarily limited thereto.

The respective components included in the autonomous driving map generation device 200 may cooperate with each other through a communication path connecting software modules or hardware modules within the device. These components perform communication using one or more communication buses or signal lines.

Each component of the autonomous driving map generation device 200 shown in FIG. 2B refers to a unit that performs at least one function or operation, and may be implemented as a software module, a hardware module, or a combination thereof. The integrated map generating part 250 reflects the fixed position corresponding to the fixed object 110 in an integrated high-precision map for autonomous driving. The integrated map generating part 250 reflects, in the integrated high-precision map, the position of the fixed object based on the fixed object marker 112 corresponding to the fixed object 110 recognized on the basis of the first moving object LiDAR 124 provided in the first moving object 120. The integrated map generating part 250 reflects the position of the first moving object 120 based on the first moving object marker 122 recognized on the basis of the second moving object LiDAR 134 provided in the second moving object 130, in the integrated high-precision map. The integrated map generating part 250 reflects the position of the second moving object based on the second moving object marker 132 recognized on the basis of the second moving object LiDAR 134, in the integrated high-precision map.

The integrated map generating part 250 reflects the fixed position corresponding to the fixed object 110 located in the terminal per yard in the integrated high-precision map.

The integrated map generating part 250 recognizes the fixed object marker corresponding to the fixed object 110 on the basis of the first moving object LiDAR 124. The integrated map generating part 250 recognizes the hidden fixed object marker 112 corresponding to the fixed object 110 hidden by cargo blocks stacked in the terminal on the basis of the first moving object LiDAR 124. The integrated map generating part 250 reflects the position of the fixed object 110 based on the fixed object marker 112 and the position of the hidden fixed object 110 based on the hidden fixed object marker 112 in the integrated high-precision map.

The integrated map generating part 250 recognizes a plurality of first moving object markers 122 respectively corresponding to a plurality of first moving objects 120 on the basis of the first moving object LiDAR 124. The integrated map generating part 250 reflects the respective positions of the plurality of first moving objects 120 based on the plurality of first moving object markers 122 in the integrated high-precision map.

The integrated map generating part 250 recognizes a plurality of second moving object markers 132 respectively corresponding to a plurality of second moving objects 130 on the basis of the second moving object LiDAR 134. The integrated map generating part 250 reflects the respective positions of the plurality of second moving objects 130 based on the plurality of second moving object markers 132 in the integrated high-precision map.

The autonomous driving providing part 260 transmits the integrated high-precision map to the first moving object 120 and the second moving object 130 for autonomous driving.

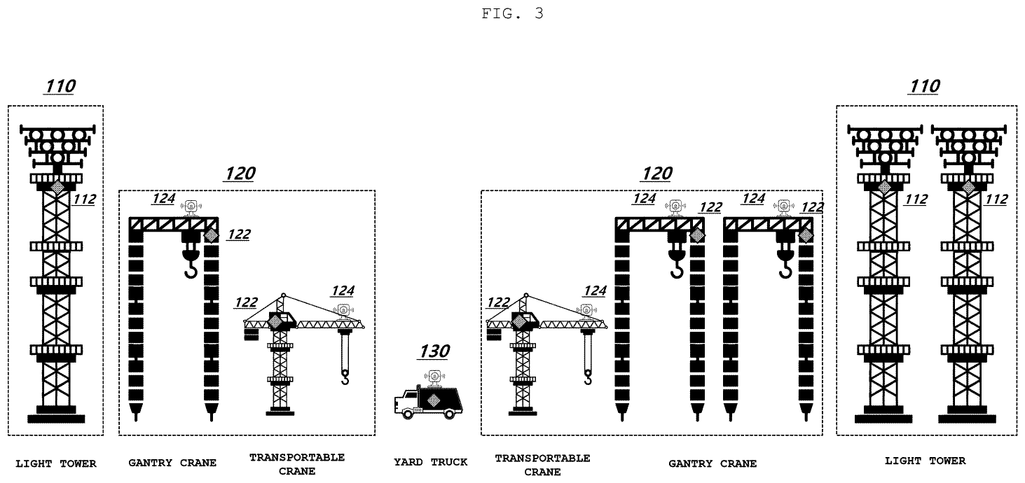

FIG. 3 is a diagram showing a fixed object, a first moving object, a second moving object located in a terminal according to an embodiment of the invention.

Here, the marker is called an identifier or DNA. The marker may be expressed in various names as a term used in a high-precision map for autonomous driving.

The yard truck recognizes the shape of the marker using a sensor such as a LiDAR for autonomous driving. The yard truck recognizes at least three markers to measure a current position of an autonomous vehicle.

The fixed object 110 includes a light tower located in a terminal. The fixed object 110 includes a fixed object marker 112 with fixed GPS latitude and longitude values.

The first moving object 120 includes a gantry crane or a transportable crane located in the terminal. The first moving object 120 moves at a speed equal to or smaller than a predetermined first speed (e.g., 5 km/h). The first moving object 120 includes a first moving object marker 122 having a relative position value and moving at the predetermined first speed. The first moving object 120 includes a first moving object LiDAR 124 that recognizes the fixed object marker 112, the hidden fixed object marker 112, and the first moving object marker 122.

The second moving object 130 includes a yard truck, an external truck, or a reach stacker that can perform autonomous driving with cargo blocks loaded thereon in the terminal. The second moving object 130 moves at a speed greater than a predetermined second speed. The second moving object 130 includes a second moving object marker 132 having a relative position value and moving at the predetermined second speed. The second moving object 130 includes a second moving object LiDAR that recognizes the fixed object marker 112, the first moving object marker 122, and the second moving object marker 132.

The second moving object 130 receives a third high-precision map. As a result of comparison with the third high-precision map, in a case where three or more fixed object markers 112 and first moving object markers 122 recognized using the second moving LiDAR 134 are recognized, the second moving object 130 measures its own position for autonomous driving on the basis of the three or more fixed object markers 112 and first moving object markers 122.

The first moving object LiDAR 124 is attached to the first moving object 120, which is the largest moving object, to recognize objects using a sensor for long-distance or mid-distance recognition. The second moving object LiDAR 134 is attached to the second moving object 130 which is smaller than the first moving object 120, and recognizes objects using a sensor for short-distance recognition. The fixed object marker 112 is a recognition target attached to a fixed object (fixed position).

The first moving object marker 122 is a recognition target attached to the first moving object 120, which is the largest one. The first moving object marker 122 moves with the first moving object 120.

The second moving object marker 132 is a recognition target attached to the second-acting 130, which is smaller than the first moving object 120. The second moving object marker 132 moves with the second moving object 130.

In managing the moving object in a high-precision map for autonomous driving, the autonomous driving map generation device 200 additionally reflects a marker attached to the moving object as marker information similar to the fixed object marker, in the high-precision map for autonomous driving.

The autonomous driving map generation device 200 recognizes the fixed object marker 112 provided in the fixed object 110, and reflects the result in the first high-precision map.

The autonomous driving map generation device 200 recognizes the fixed vehicle marker 112 using the first moving object LiDAR 124 provided in the first moving object 120, and reflects a real-time position of the first moving object 120 in the second high-precision map.

The autonomous driving map generation device 200 recognizes the first moving object marker 122 of the first moving object 120 using the second moving object LiDAR 134 provided in the second moving object 130, recognizes the fixed object marker 112 of the fixed object 110 if not hidden, and reflects the position of the second moving object 130 in the third high-precision map.

The autonomous driving map generation device 200 recognizes the position of the second moving object 130 in real time on the basis of the fixed object marker 112 and the first moving object marker 122 recognized using the second moving object LiDAR 134 provided in the second moving object 130.

In recognizing the fixed object marker 112 and the first moving object marker 122 in the terminal for autonomous driving of the yard truck, in a case where the fixed object marker 112 is hidden by surrounding environments (stacked cargo blocks), the autonomous driving map generation device 200 additionally may recognize a marker (first moving object marker 122) attached to a surrounding moving object to recognize the position of the autonomous vehicle in real time.

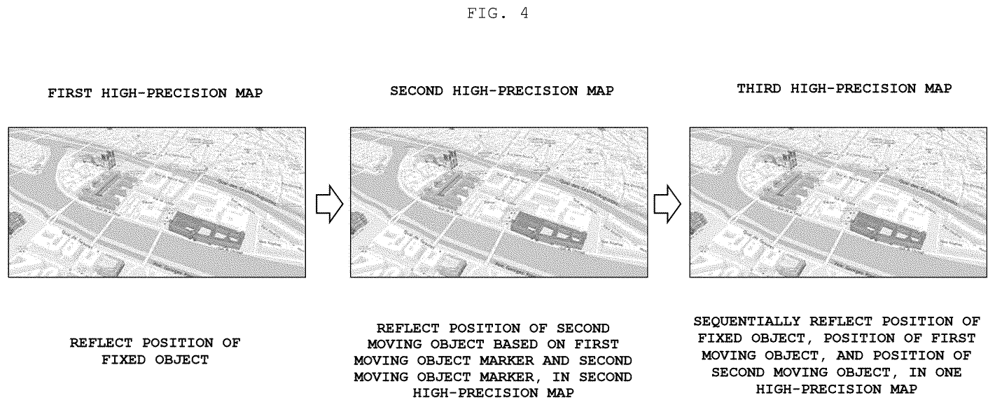

FIG. 4 is a diagram showing a first high-precision map, a second high-precision map, and a third high-precision map according to the first embodiment of the present invention.

The first high-precision map refers to a map that includes the fixed object marker 112 of the fixed object 110 in the map. The first high-precision map is a high-precision map based on the position of the fixed object 110.

The second high-precision map refers to a map that additionally includes the first moving object marker 122 of the first moving object 120 in the first-time-high-precision map. The second high-precision map is a high-precision map that additionally includes the position of the first moving object 120 in the first high-precision map.

The third high-precision map refers to a map that additionally includes the second moving object marker 132 of the second moving object 130 in the second high-precision map. The third high-precision map is a high-precision map that additionally includes the position of the second moving object 130 in the second high-precision map.

The autonomous driving map generation device 200 according to the present embodiment generates the first high-precision map, the second high-precision map, and the third high-precision map, respectively.

The first high-precision map, second high-precision map, and third high-precision map include x, y, z coordinates and attribute information on the fixed object marker 112, the first moving object marker 122, and the second moving object marker 132, and have sizes from 5 KB to 5 MB.

The autonomous driving map generation device 200 according to the present embodiment first generates the first high-precision map on the basis of the fixed object marker 112. The autonomous driving map generation device 200 generates the second high-precision map that reflects the first moving object marker 122 corresponding to the first moving object 120 in real time on the basis of the first high-precision map.

The autonomous driving map generation device 200 generates the third high-precision map that reflects the second moving object marker 132 corresponding to the second moving object 130 in real time on the basis of the second high-precision map.

The autonomous driving map generation device 200 according to the present embodiment measures the positions of the plurality of second moving objects 130 and reflects the result in the third high-precision map in generating the third high-precision map. In other words, the autonomous driving map generation device 200 measures the positions of all the second moving objects 130 during autonomous driving and reflects the result in the third high-precision map.

In particular, the positions of external trucks in addition to yard trucks may be applied to improve the positioning accuracy of all the second moving objects 130 during autonomous driving in the terminal.

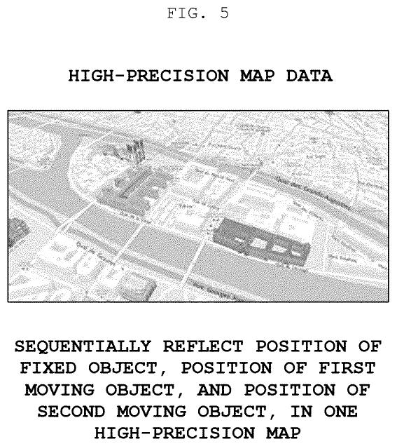

FIG. 5 is a diagram showing a high-precision map according to a second embodiment of the present invention.

The autonomous driving map generation device 200 according to the present embodiment reflects the position information on the fixed object 110 based on the fixed object marker 112, reflects the position information on the first moving object 120 based on the fixed object marker 112, and reflects the position information on the second moving object 130 based on the fixed object marker 112, the first moving object marker 122, and the second moving object marker 132, in one high-precision map.

The above description has been made for only exemplary embodiments of the technical idea of the present invention, and those skilled in the art will be able to make various modifications and changes to the extent without departing from the characteristics of the invention. Therefore, the exemplary embodiments are not intended to limit the scope of the technical idea of the. The scope of protection of the invention should be interpreted in accordance with claims below, and all technical ideas within the equivalent scope should be interpreted as being within the scope of the invention.

1. An autonomous driving map generation device comprising:
a fixed object-based map generating part that generates a first high-precision map for autonomous driving on the basis of a fixed position corresponding to a fixed object;
a first moving object-based map generating part that recognizes a fixed object marker corresponding to the fixed object on the basis of a first moving object LiDAR provided in a first moving object to generate a second high-precision map for autonomous driving;
a second moving object-based map generating part that recognizes a first moving object marker corresponding to the first moving object on the basis of a second moving object LiDAR provided in a second moving object to generate a third high-precision map for autonomous driving; and
an autonomous driving providing part that transmits the second high-precision map to the first moving object for autonomous driving, and transmits the third high-precision map to the second moving object for autonomous driving.

2. The autonomous driving map generation device according to claim 1, wherein the fixed object-based map generating part additionally reflects the fixed position corresponding to the fixed object located in a terminal per yard to generate the first high-precision map for autonomous driving.

3. The autonomous driving map generation device according to claim 1, wherein the first moving object-based map generating part recognizes the fixed object marker corresponding to the fixed object on the basis of the first moving object LiDAR, recognizes the fixed object marker corresponding to the fixed object hidden by cargo blocks stacked in the terminal on the basis of the first moving object LiDAR, and additionally reflects the position of the fixed object based on the fixed object marker and the position of the hidden fixed object based on the hidden fixed object marker in the first high-precision map to generate the second high-precision map for autonomous driving.

4. The autonomous driving map generation device according to claim 1, wherein the first moving object-based map generating part recognizes the plurality of first moving object markers respectively corresponding to the plurality of first moving objects on the basis of the first moving object LiDAR and additionally reflects the positions of the plurality of first moving objects based on the plurality of first moving object markers in the first high-precision map to generate the second high-precision map for autonomous driving.

5. The autonomous driving map generation device according to claim 1, wherein the second moving object-based map generating part recognizes the plurality of second moving object markers respectively corresponding to the plurality of second moving objects on the basis of the second moving object LiDAR and additionally reflects the positions of the plurality of second moving objects based on the plurality of second moving object markers in the second high-precision map to generate the third high-precision map for autonomous driving.

6. The autonomous driving map generation device according to claim 1, wherein the fixed object includes a light tower located in a terminal, and the fixed object marker with fixed GPS latitude and longitude values.

7. The autonomous driving map generation device according to claim 1, wherein the first moving object includes a gantry crane or a transportable crane moving at a speed equal to or smaller than a predetermined first speed in a terminal, includes the first moving object marker having a relative position value and moving at the predetermined first speed, and includes a first moving object LiDAR that recognizes the fixed object marker, the hidden fixed object marker, and the first moving object marker.

8. The autonomous driving map generation device according to claim 1, wherein the second moving object includes a yard truck, an external truck, or a reach stacker that performs autonomous driving with cargo blocks loaded thereon and moves at a speed greater than a predetermined second speed in a terminal, includes the second moving object marker having a relative position value and moving at the predetermined second speed, and includes a second moving object LiDAR that recognizes the fixed object marker, the first moving object marker, and the second moving object marker.

9. The autonomous driving map generation device according to claim 1, wherein the second moving object receives a third high-precision map, and compares, in a case where there are three or more fixed object markers and first moving object markers recognized using the second moving LiDAR, the three or more fixed object markers and first moving object markers with the third high-precision map to measure its own position for autonomous driving.

10. An autonomous driving map generation device comprising:
an integrated map generating part that reflects a fixed position corresponding to a fixed object, reflects a position of the fixed object based on a fixed object marker corresponding to the fixed object recognized on the basis of a first moving object LiDAR provided in a first moving object, reflects a position of the first moving object based on a first moving object marker recognized on the basis of a second moving object LiDAR provided in a second moving object, and reflects a position of the second moving object based on a second moving object marker recognized on the basis of the second moving object LiDAR, in an integrated high-precision map for autonomous driving; and
an autonomous driving providing part that transmits the integrated high-precision map to the first moving object and the second moving object for autonomous driving.

11. The autonomous driving map generation device according to claim 10, wherein the integrated map generating part reflects the fixed position corresponding to the fixed object located in a terminal per yard in the integrated high-precision map.

12. The autonomous driving map generation device according to claim 10, wherein the integrated map generating part recognizes the fixed object marker corresponding to the fixed object on the basis of the first moving object LiDAR, recognizes the hidden fixed object marker corresponding to the fixed object hidden by cargo blocks stacked in the terminal on the basis of the first moving object LiDAR, and reflects the position of the fixed object based on the fixed object marker and the position of the hidden fixed object based on the hidden fixed object marker, in the integrated high-precision map.

13. The autonomous driving map generation device according to claim 10, wherein the integrated map generating part recognizes the plurality of first moving object markers respectively corresponding to the plurality of first moving objects on the basis of the first moving object LiDAR, and reflects the positions of the plurality of first moving objects based on the plurality of first moving object markers in the integrated high-precision map.

14. The autonomous driving map generation device according to claim 10, wherein the integrated map generating part recognizes the plurality of second moving object markers respectively corresponding to the plurality of second moving objects on the basis of the second moving object LiDAR, and reflects the positions of the plurality of second moving objects based on the plurality of second moving object markers in the integrated high-precision map.
